(19) United States
(12) Patent Application Publication
(10) Pub. No.: US 2005/0270969 A1
(43) Pub. Date: Dec. 8, 2005

(54) Apparatus and method for providing a broadcasting service in a mobile communication system

(76) Inventors: Jin-Kyu Han, Suwon-si (KR); Dae-Gyun Kim, Seongnam-si (KR); Jin-Weon Chang, Suwon-si (KR); Beom-Sik Bae, Suwon-si (KR); Hwan-Joon Kwon, Suwon-si (KR); Dong-Hee Kim, Yongin-si (KR); Youn-Sun Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/113,326

(22) Filed: Apr. 25, 2005

(30) Foreign Application Priority Data
Apr. 24, 2004 (KR) 2004-28524

(51) Int. Cl. H04J 11/00

(52) U.S. Cl. 370/210

(57) ABSTRACT

An apparatus and method for providing a broadcasting service in a mobile communication system. The apparatus and method can transmit broadcasting service data using orthogonal frequency division multiplexing (OFDM) symbols in the mobile communication system. Broadcasting service data is encoded and modulated. The modulated data is demultiplexed into data streams corresponding to a number of orthogonal frequency subcarriers. The data streams are transformed using Fast Fourier Transform (FFT). The transformed data streams are multiplexed using OFDM. Information with a predetermined length placed in a last part of OFDM data is copied. The copied information is added as a cyclic prefix (CP) to a head part of the OFDM data, and OFDM symbols to be transmitted are generated. The generated OFDM symbols are multiplexed into a forward channel of the mobile communication system, and the multiplexed OFDM symbols are transmitted.

### PRIORITY

This application claims the benefit under 35 U.S.C. §119(a) of to an application entitled “Apparatus and Method for Providing a Broadcasting Service in a Mobile Communication System” filed in the Korean Intellectual Property Office on Apr. 24, 2004 and assigned Ser. No. 2004-28524, the entire contents of which are incorporated herein by reference. S

### BACKGROUND OF THE INVENTION

1. Field of the Invention

The present invention relates generally to an apparatus and method for providing a broadcasting service in a mobile communication system. More particularly, the present invention relates to an apparatus and method for providing a broadcasting service in a mobile communication system capable of transmitting packet data.

2. Description of the Related Art

Mobile communication systems were initially developed to provide voice communication. With the development of technology, the mobile communication systems have developed into systems capable of providing various types of data services. Accordingly, the mobile communication systems can provide various services such as short message services, Internet services, e-mail services, and broadcasting services.

The broadcasting services from among the various services will be described. The broadcasting services are classified into terrestrial broadcasting services, which are broadcasting services capable of being provided from the mobile communication system, digital multimedia broadcasting (DMB) services and digital video broadcasting-handheld (DVB-H), which are services capable of being received by portable terminals. The broadcasting services are being developed such that they can be provided to fixed terminals at a high data rate and can be provided to mobile terminals at a lower data rate via a in wireless transfer mode.

These broadcasting services are conventionally provided in one way. That is, when a transmitter unilaterally transmits a broadcasting service, a receiver only receives the broadcasting service. Accordingly, there is no available method capable of reflecting a user request in the broadcasting service. To address this problem, a large amount of research is being done on two-way services associated with broadcasting. A method for exploiting the conventional wired/wireless communication network as a return channel is taken into account such that the two-way broadcasting services can be provided. This approach has limitations in implementing a basic two-way broadcasting scheme because broadcasting and communication use different data transfer modes.

Service supported in the mobile communication system for transmitting packet data is a communication service for exchanging information between a specific transmitter and a specific receiver. In this communication service, users transmit and receive information through different channels. However, because channel environments of the mobile communication system have low isolation between channels, performance is limited due to interference. To increase isolation between channels, the conventional mobile communication system uses a cellular concept in a multiple access scheme such as code division multiple access (CDMA), time division multiple access (TDMA), or frequency division multiple access (FDMA). However, because these schemes cannot basically suppress interference, interference still acts as a limiting factor in performance.

In addition to the mobile communication system capable of providing the broadcasting service, other broadcasting systems are a digital video broadcasting-terrestrial (DVB-T) system, a DVB-H system, a digital audio broadcasting (DAB) system, and the like. These systems typically transmit broadcast data using an orthogonal frequency division multiplexing (OFDM) scheme.

The OFDM scheme used in the broadcasting system has a number of advantages. Namely, when the OFDM scheme is used, self-interference due to multipath fading can be avoided. More specifically, because different base stations transmit the same broadcasting signal through a single frequency network (SFN) in the broadcasting service, OFDM signals from different base stations can be received without interference. Accordingly, when the OFDM scheme is applied to the broadcasting service, a non-interference environment can be implemented, such that transmission efficiency can be maximized.

The ongoing broadcasting service is used in the current mobile communication system without being modified. This mobile communication system provides a broadcasting service through a scheme different from that of other broadcasting systems. That is, the broadcasting service system transmits information from a transmitter to a plurality of receivers through the same channel. Accordingly, because users receiving the same information share the same channel, interference between users does not occur.

However, because the mobile communication system basically adopts a cellular system, base stations cannot transmit data using the same channel. Accordingly, the mobile communication system performance degrades due to a phenomenon of multipath fading occurring in a high-speed mobile environment, and has other factors, which also degrades performance.

A high rate packet data (HRPD) system being currently developed to provide the broadcasting service in the mobile communication system will be described. A forward link in the HRPD system uses a TDMA scheme as a multiple access scheme, and uses a time division multiplexing/code division multiplexing (TDM/CDM) scheme as its multiplexing scheme. A slot structure of data to be transmitted through a forward link in the HRPD system will be described with reference to FIG. 1. FIG. 1 illustrates a structure of one slot in which data is transmitted through the forward link in the HRPD system.

One slot illustrated in FIG. 1 is divided into two half slots. A half slot is repeated within the one slot. The one slot includes data parts 101, 105, 106, and 110, and medium access control (MAC) information parts 102, 104, 107, and 109. N_{Pilot}-chip pilot parts 103 and 108 are inserted into the centers of the half slots, respectively. A pilot signal is used to estimate a channel of the forward link in a receiving terminal. The N_{MAC}-chip MAC information parts 102, 104, 107, and 109 including reverse power control (RPC) information and resource allocation information are transmitted on both sides of the pilot parts 103 and 108. The N_{Data}-chip data parts 101, 105, 106, and 110 are transmitted on the outer sides of the MAC information parts. The half slots with the repeat form configure the one slot. Data to be transmitted in the forward direction in the HRPD system is multiplexed according to the TDM scheme in which pilot parts, MAC information parts, and data parts are transmitted at different times.

The MAC information parts and the data parts are multiplexed according to the CDM scheme using Walsh codes. In the forward link of the HRPD system serving as one of the CDM systems, a unit size of each pilot block illustrated in FIG. 1 is shown set to N_{Pilot}=96 chips, a unit size of each MAC information block illustrated in FIG. 1 is set to N_{MAC}=64 chips, and a unit size of each data block illustrated in FIG. 1 is set to N_{Data}=400 chips. FIG. 2 illustrates a structure of a transmitter of the forward link in the HRPD system.

The transmitter of an HRPD base station includes a data signal generator 201 for generating data to be transmitted according to a multicode scheme, a preamble signal generator 202 for generating a signal indicating the start of a packet, an MAC signal generator 204 for generating a signal including control information of which each user is notified, and a pilot signal generator 205 for generating a signal for channel estimation and sync acquisition. A time division multiplexing (TDM) process 207 is performed in the form of a slot illustrated in FIG. 1. A preamble is arranged before data to be transmitted. Data of the data signal generator 201 and a signal of the MAC signal generator 204 include two signal streams with in-phase (I) and quadrature (Q) components, respectively. On the other hand, the preamble signal generator 202 and the pilot signal generator 205 generate one signal stream having the I component, respectively. As indicated by reference numerals 203 and 206, the Q components have 0 signals. Each signal is generated per pseudorandom noise (PN) chips.

When the slot structure of FIG. 1 is completed through the TDM process, a quadrature spreader 208 performs quadrature spread using a PN code used in each base station, and modifies the transmission signal. Baseband filters 209 and 210 filter signal streams to be transmitted through I and Q channels such that the modified signal can satisfy band-limiting characteristics. A multiplier multiplies the I channel signal of the filtered signals by a cosine carrier generated from a cosine carrier generator 211. A multiplier multiplies a Q channel signal of the filtered signals by a sine carrier generated from a sine carrier generator 212. A radio frequency (RF) signal is generated from the multiplied signals. A summer 213 sums I and Q channel signals, and transmits the result of the summation.

A process after the generators 201, 202, 204, and 205 generate data, preamble, MAC, and pilot signals has been described with reference to FIG. 2. A process for generating each signal will be described in more detail with reference to FIGS. 3 to 6.

FIG. 3 is a block diagram illustrating the data signal generator 201 of FIG. 2. The configuration and operation of the data signal generator 201 will be described with reference to FIG. 3.

When a data source generator 301 generates a broadcasting signal to be transmitted, a channel encoder 302 encodes the broadcasting signal, and an adder scrambles the encoded broadcasting signal with a scrambling code. Reference numeral 303 of FIG. 3 denotes a device for generating the scrambling code to be used for scrambling. That is, a scrambling code signal generated from the scrambling code generator 303 and an encoded data signal output from the channel encoder 302, are scrambled through a mod-2 operation. Scrambled data is input to a channel interleaver 304. The channel interleaver 304 interleaves the input data. That is, the channel interleaver 304 interleaves the input data in the time domain. The channel interleaver 304 can overcome a phenomenon in which reception capability is degraded due to a suddenly degraded channel state, by using time diversity. A modulator 305 modulates a signal output from the channel interleaver 304, and a sequence repeater/symbol puncturer 306 performs a repetition/puncturing operation on the modulated signal on the basis of a transmission rate. Subsequently, a symbol demultiplexer 307 demultiplexes a serially input repeated and punctured signal into 16 parallel signals. The parallel signals are for CDM based on a multicode scheme. The 16 signal streams are input to a Walsh cover multiplier 308, and are multiplied by different Walsh codes. The transmission power for signals multiplied by Walsh covers is normalized in a channel gain processor 309. A Walsh chip level summer 310 sums 16 Walsh channel signals in a chip level, and completes a data signal of the data signal generator 201.

FIG. 4 is a block diagram illustrating the preamble signal generator 202 of FIG. 2. The configuration and operation of the preamble signal generator 202 will be described with reference to FIG. 4.

A preamble signal source is entirely composed of 0's. This preamble digital signal is denoted by reference numeral 401 of FIG. 4. The preamble signal is input to a signal point mapper 402, and is changed to an antipodal signal configured by +1 and −1. The preamble signal is used to indicate a user of a packet to be transmitted. A multiplier multiplies the changed preamble signal by a 64-symbol bi-orthogonal signal associated with an MAC index “i” of a user generated from a generator 403. Accordingly, a receiving terminal recovers a preamble signal by multiplying its own MAC index by a corresponding bi-orthogonal signal, and can determine if a corresponding packet is destined therefor. A stream or sequence of the generated preamble signal is repeated in a repeater 404. The preamble signal as indicated by reference numeral 202 of FIG. 2 is completed.

FIG. 5 is a block diagram illustrating the MAC signal generator 204 of FIG. 2. The configuration and operation of the MAC signal generator 204 of FIG. 2 will be described with reference to FIG. 5.

Information to be sent through an MAC signal includes control signals of a reverse power control (RPC) bit source generator 501, a hybrid automatic repeat request (H-ARQ) or layered automatic repeat request (L-ARQ) bit source generator 502, a punctured automatic repeat request (P-ARQ) bit source generator 503, a data rate control (DRC) lock bit generator 504, a Reset-Ack (RA) bit source generator 505 and so on. Because each bit is not directly associated with the present invention, a description of each will be omitted for the sake of clarity and conciseness. Only a process for generating an MAC signal from the MAC signal generator 204 will be described.

A signal point mapper 506 maps an RPC bit from the RPC bit source generator 501 to an antipodal signal, and a RPC channel gain processor 507 applies a channel gain defined by the RPC bit to a result of the mapping. An H-ARQ or L-ARQ bit from the H-ARQ or L-ARQ bit source generator 502 changes the signal mapping method according to an ARQ state. After an ARQ signal point mapper 508 performs a signal point mapping operation appropriate for each state, an ARQ channel gain processor 509 applies an ARQ channel gain to a result of the mapping. The RPC bit from the RPC bit source generator 501 is transmitted in the last slot of four slots. In three previous slots, the H-ARQ or L-ARQ bit from the H-ARQ or L-ARQ bit generator 502 is transmitted. Accordingly, a time division multiplexer 510 multiplexes two signals preferably at a ratio of 1:3.

A signal point mapper 511 maps a P-ARQ bit from the P-ARQ bit generator 503 to an antipodal signal, and an ARQ channel gain processor 512 applies a channel gain defined by the P-ARQ bit to a result of the mapping. A DRC lock bit from the DRC lock bit source generator 504 is repeated according to the DRC lock length or four times. Subsequently, a signal point mapper 514 maps the repeated signal to an antipodal signal, and a channel gain processor 515 applies a DRC lock channel gain to a result of the mapping. The DRC lock bit from the DRC lock bit source generator 504 is transmitted in the last slot among four slots. The P-ARQ bit from the P-ARQ bit source generator 503 is transmitted in three previous slots. A time division multiplexer 516 multiplexes the DRC lock bit and the P-ARQ bit according to TDM preferably at a ratio of 3:1.

Because signals output from the two time division multiplexers 510 and 516 are control signals to be individually sent to each user, a 128-ary Walsh code associated with an MAC index of each user must be multiplied. Accordingly, signals generated from a Walsh code generator 517 are output to multipliers associated with the time division multiplexers 510 and 516, and are multiplied by signals output from the time division multiplexers 510 and 516, such that the multiplication results are output. That is, individual user signals are generated according to a CDMA scheme.

A method for mapping signals generated as described above to I and Q channels will be described. The method for mapping the generated signals to the I and Q channels differs according to MAC index. When the MAC index is an even number, output of the time division multiplexer 510 is mapped to an I channel, and output of the time division multiplexer 516 is mapped to a Q channel. In contrast, when the MAC index is an odd number, output of the time division multiplexer 510 is mapped to a Q channel, and output of the time division multiplexer 516 is mapped to an I channel. The I/Q channel signal point mappers 518 and 519 are devices for mapping signals of the I and Q channels. Through the process 520, an MAC signal to be sent to each user is completed.

A signal generated from the RA bit source generator 505 is mapped to an antipodal signal in a signal point mapper 521. A channel gain processor 522 applies an RA channel gain to a result of the mapping. The signal generated from the RA bit source generator 505 is information to be sent to all users managed by a base station rather than information to be sent to an individual user. Accordingly, a signal generated from a Walsh code generator 523 for generating a fixed Walsh code (for example, Code 2 of 128-ary Walsh codes) is multiplied in a multiplier. An RA bit source signal is output to an I channel.

The MAC signals to be sent to respective users are completed through the process 520. When RA bits are completed, a Walsh chip level summer 524 sums the RA bits. A sequence repeater 525 repeats a signal stream according to transmission size, such that an MAC signal as indicated by reference numeral 204 of FIG. 2 is completed.

FIG. 6 is a block diagram illustrating the pilot signal generator 205 of FIG. 2. The configuration and operation of the pilot signal generator 205 of FIG. 2 will be described with reference to FIG. 6.

A pilot source generator 601 generates a pilot digital signal entirely composed by 0's. A signal point mapper 602 generates an antipodal signal configured by +1 and −1 from the pilot digital signal. When Walsh Code 0 generated from a Walsh Code-0 generator 603 is multiplied by a mapped signal, the pilot signal as indicated by reference numeral 205 of FIG. 2 is completed.

The slot and transmitter structures for the HRPD forward link are designed for the purpose of wireless packet mobile communication. Of course, the slot and transmitter structures for the HRPD forward link can be used for the conventional broadcast and multicast service (BCMCS).

When data is transmitted to the forward link in the HRPD system, the TDM/CDM scheme employed in the HRPD system generates self-interference in a multipath fading channel. That is, because multipath signals reach a terminal at different times, a later received signal interferes with an adjacent symbol of an earlier received signal. In a cellular mobile communication system, a signal transmitted from a different base station causes intercell interference. The above-mentioned self-interference and intercell interference become basic factors limiting mobile communication performance.

An important criterion of performance in the broadcasting service is that uniform quality of service (QoS) is ensured in a service area. When a terminal receiver is close to a base station in the conventional wireless packet mobile communication system, high throughput performance is provided. In contrast, when a terminal receiver is located on a cell boundary, low throughput performance is provided. Accordingly, there is a problem in that the conventional HRPD forward link transmission scheme is not suitable for wireless packet mobile communication.

### SUMMARY OF THE INVENTION

It is, therefore, an aspect of the present invention to provide an apparatus and method for efficiently providing a broadcasting service in a mobile communication system.

It is another aspect of the present invention to provide an apparatus and method for providing a broadcasting service in a mobile communication system that can support a two-way service.

It is another aspect of the present invention to provide an apparatus and method that can provide a broadcasting service while avoiding intercell interference in a mobile communication system.

It is yet another aspect of the present invention to provide an apparatus and method that can provide a broadcasting service while avoiding performance degradation due to interference between receivers in a mobile communication system.

The above and other aspects of the present invention can be achieved by a method for providing a broadcasting service in a mobile communication system for transmitting packet data. The method comprises encoding and modulating broadcasting service data, and demultiplexing the modulated data into data streams corresponding to a number of orthogonal frequency subcarriers, transforming the data streams using Fast Fourier Transform (FFT), and multiplexing the transformed data streams using orthogonal frequency division multiplexing (OFDM), copying information with a predetermined length placed in a last part of OFDM data, adding the copied information as a cyclic prefix (CP) to a head part of the OFDM data, generating OFDM symbols to be transmitted; and multiplexing the generated OFDM symbols into a forward channel of the mobile communication system, and transmitting the multiplexed OFDM symbols.

The above and other aspects of the present invention can be achieved by an apparatus for providing a broadcasting service in a high rate packet data (HRPD) system. The apparatus comprises an encoder for performing a channel encoding operation on broadcasting service data according to a predetermined encoding scheme, a modulator for modulating the encoded broadcasting service data according to a predetermined modulation scheme, a demultiplexer for demultiplexing the modulated data into data streams corresponding to a number of orthogonal frequency subcarriers, a Fast Fourier Transform (FFT) processor for transforming the data streams using FFT, and multiplexing the transformed data streams using orthogonal frequency division multiplexing (OFDM), a cyclic prefix (CP) adder for copying information with a predetermined length placed in a last part of OFDM data, adding the copied information as a CP to a head part of the OFDM data, and generating OFDM symbols to be transmitted, and a multiplexer for multiplexing the generated OFDM symbols into a forward channel of the mobile communication system.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a structure of one slot to be transmitted to a forward link in a conventional high rate packet data (HRPD) system;

FIG. 2 is a block diagram illustrating a structure of a transmitter of the forward link in the conventional HRPD system;

FIG. 3 is a block diagram illustrating a data signal generator of FIG. 2;

FIG. 4 is a block diagram illustrating a preamble signal generator of FIG. 2;

FIG. 5 is a block diagram illustrating a medium access control (MAC) signal generator for generating an MAC signal in FIG. 2;

FIG. 6 is a block diagram illustrating a pilot signal generator of FIG. 2;

FIG. 7 illustrates a slot structure for transmitting a forward compatible orthogonal frequency division multiplexing (OFDM) symbol in an HRPD system in accordance with an embodiment of the present invention;

FIG. 8 illustrates a structure of one slot with a uniform OFDM symbol size in the HRPD system in accordance with an embodiment of the present invention;

FIG. 9 illustrates an example in which some OFDM symbols are used as OFDM pilot symbols when OFDM symbols have different sizes according to an embodiment of the present invention;

FIG. 10 illustrates a structure of a conventional transmission OFDM symbol;

FIG. 11 is a block diagram illustrating a base station for transmitting the forward compatible OFDM symbol slot illustrated in FIGS. 7 to 9 in the HRPD system;

FIG. 12 is a flow chart illustrating an operation for processing received data in a receiver when a transmitter sends parameters according to an embodiment of the present invention;

FIG. 13 is a flow chart illustrating an operation for processing received data in a receiver when a transmitter does not send a parameter according to an embodiment of the present invention;

FIG. 14 illustrates a slot structure of a forward link in a conventional universal mobile telecommunications system (UMTS) system in frequency domain duplex (FDD) mode;

FIG. 15 illustrates a structure of a slot for providing a broadcasting service using an OFDM symbol in a UMTS system in accordance with an embodiment of the present invention;

FIG. 16 illustrates a conventional slot structure of a forward link in a universal mobile telecommunications system (UMTS) system in time domain duplex (TDD) mode; and

FIG. 17 illustrates a structure of a slot for providing a broadcasting service using an OFDM symbol in a UMTS system in accordance with an embodiment of the present invention.

Throughout the drawings, it should be understood that like reference numerals are used to refer to like features, structures and elements.

### DETAILED DESCRIPTION OF EXEMPLARY EMBODIMENTS

Exemplary embodiments of the present invention will be described in detail herein below with reference to the accompanying drawings. In the following description made in conjunction with exemplary embodiments of the present invention, a variety of specific elements are shown. The description of such elements has been made only for a better understanding of the present invention. Those skilled in the art will appreciate that the present invention can be implemented without using the above-mentioned specific elements. Additionally, in the following description, a detailed description of known functions and configurations incorporated herein will be omitted for the sake of conciseness.

Embodiments of the present invention provide a mobile communication system for preventing self-interference from occurring in a multipath fading channel by using an orthogonal frequency division multiplexing (OFDM) scheme as a multiplexing scheme. A broadcasting service is designed such that all base stations transmit the same information. Accordingly, a terminal receiver is configured as if it receives a broadcasting signal undergoing a multipath fading channel from one base station. Intercell interference can be prevented through the OFDM scheme. That is, the mobile communication system according to embodiments of the present invention can avoid intercell interference, and can prevent performance degradation in the terminal receiver located on a cell boundary, by using the OFDM scheme. The mobile communication system of the present invention can ensure uniform quality of service (QoS) across a broadcasting service area. The mobile communication system according to embodiments of the present invention improves the conventional wireless packet mobile communication system, such that two-way communication can be easily implemented, and a broadcasting service is efficiently provided in a high-speed mobile environment.

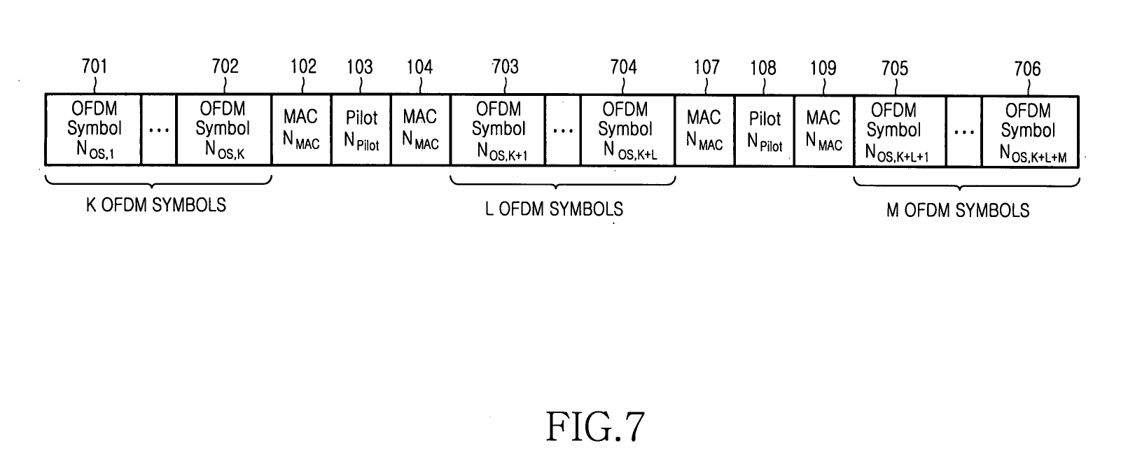

FIG. 7 illustrates a slot structure for transmitting a forward compatible OFDM symbol in a high rate packet data (HRPD) system in accordance with the present invention. The slot structure for transmitting the forward compatible OFDM symbol in the HRPD system will be described in detail with reference to FIG. 7.

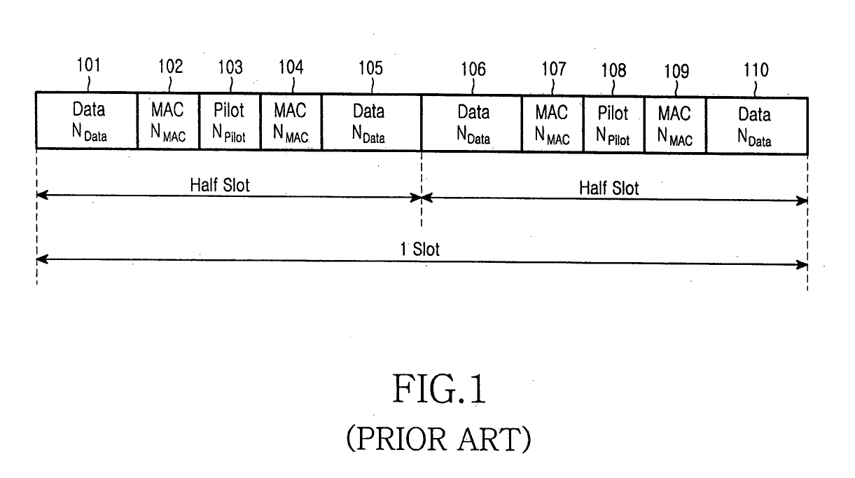

FIG. 7 illustrates one slot to be transmitted in a forward direction in the HRPD system. The one slot can be divided into two half slots. A position and size of a pilot or MAC signal is set to be the same as those of a pilot or MAC signal in the HRPD slot of FIG. 1 such that forward compatibility can be maintained in the HRPD system based on the OFDM scheme. Accordingly, the same symbols between FIGS. 1 and 7 are denoted by the same reference numerals. That is, N_{Pilot}-chip pilot parts 103 and 108 are inserted into the centers of the half slots, respectively. N_{MAC}-chip medium access control (MAC) information parts 102, 104, 107, and 109 are placed on both sides of the pilot parts. Accordingly, the conventional HRPD terminal not supporting an OFDM-based broadcasting service can estimate a channel through a pilot, and can receive a MAC signal. The OFDM symbols are inserted into the remaining parts.

The OFDM symbols will now be described in more detail. K OFDM symbols are placed before the first MAC signal part 102, where K is an integer. L OFDM symbols are placed between the second and third MAC signal parts 104 and 107, where L is an integer. M OFDM symbols are placed after the fourth MAC signal part 109, where M is an integer. FIG. 7 illustrates an example in which sizes or lengths of the OFDM symbols are different. It can be seen that either the half slot as illustrated in FIG. 7 comprises L/2 OFDM symbols if the L OFDM symbols have the same size. When the OFDM symbols have different sizes, each OFDM symbol size satisfies Equation (1) according to position, where K, L, and M are integers and N_{OS} denotes a broadcasting data symbol size.
Total number of OFDM symbols: {N_{OS,i}}_{i=1,} . . . _{,K+L+M} (Unit: chip)
K OFDM symbols: N_{OS,1}+N_{OS,2}+ . . . +N_{OS,K-1}+N_{OS,K}=N_{Data} (Unit: chip)
L OFDM symbols: N_{OS,K+1}+N_{OS,K+2}+ . . . +N_{OS,K+L-1}+N_{OS,K+L}=2N_{Data (Unit: chip)}
M OFDM symbols: N_{OS,K+L+1}+N_{OS,K+L+2}+ . . . +N_{OS,K+L+M-1}+N_{OS,K+L+M}=N_{Data} (Unit: chip) Equation (1)

If sizes of the OFDM symbols are set to be different, Inverse Fast Fourier Transform/Fast Fourier Transform (IFFT/FFT) modules with different sizes are required. Accordingly, it is advantageous that an OFDM symbol size is set to be uniform. The structure of FIG. 7 can be used when OFDM symbol sizes are different. It is preferred that OFDM symbol sizes are uniform. The system sets an OFDM symbol size while taking into account a channel environment of a terminal receiving a broadcasting service.

The OFDM symbol size is set to a sufficiently low value to effectively inhibit channel variation of a mobile terminal moving at high speed during one OFDM symbol time. When the OFDM symbol size is very small, the number of symbol elements capable of being transmitted through one OFDM symbol is reduced. A cyclic prefix (CP) is added to a head part of an OFDM symbol such that self-interference occurring in a received signal delayed due to multiple paths can be avoided. Because a size of the CP is set to be large in an environment in which frequency selective fading is serious, a CP portion in an OFDM symbol increases, but the amount of information to be transmitted is reduced when an OFDM symbol size is small. Accordingly, when an OFDM symbols size is set to be very small, transmission efficiency is degraded.

The slot structure of FIG. 7 proposed by the embodiment of the present invention can be implemented via three schemes. These three schemes will now be described in more detail.

The first scheme is that all OFDM symbol sizes are set to be uniform and are designed to be optimal for a terminal of a specific environment. The second scheme transmits OFDM symbols with different sizes in one HRPD slot. The slot structure is designed such that OFDM symbols optimal for terminals in various environments can be transmitted. The third scheme fixes an OFDM symbol size in one slot, and can vary OFDM symbol sizes in different slots. According to the third scheme, the slot structure is designed such that OFDM symbols optimal for terminals in different environments can be transmitted slot by slot. Because the third scheme has selective OFDM transfer mode, an operator can vary an OFDM transfer scheme according to the attributes of broadcasting content. For example, an OFDM symbol size can be set to be relatively large such that a transmission rate can increase in case of broadcasting content requiring a large amount of information, such as sports broadcasting. In this case, a CP size is set to be relatively small.

In contrast, an OFDM symbol size can be set to be relatively small in the case of broadcasting content requiring a small amount of information, such as drama broadcasting, such that reception quality can increase. In this case, a CP size is set to be relatively large. Alternatively, the transfer mode can be selected according to broadcasting content.

The above-described schemes can vary an OFDM symbol size and a CP size according to characteristics of broadcasting content. This is referred to as a multimode OFDM signal transmission method. Because the multimode OFDM signal transmission method can efficiently determine the OFDM transfer mode according to the environment, an efficient broadcasting service can be implemented.

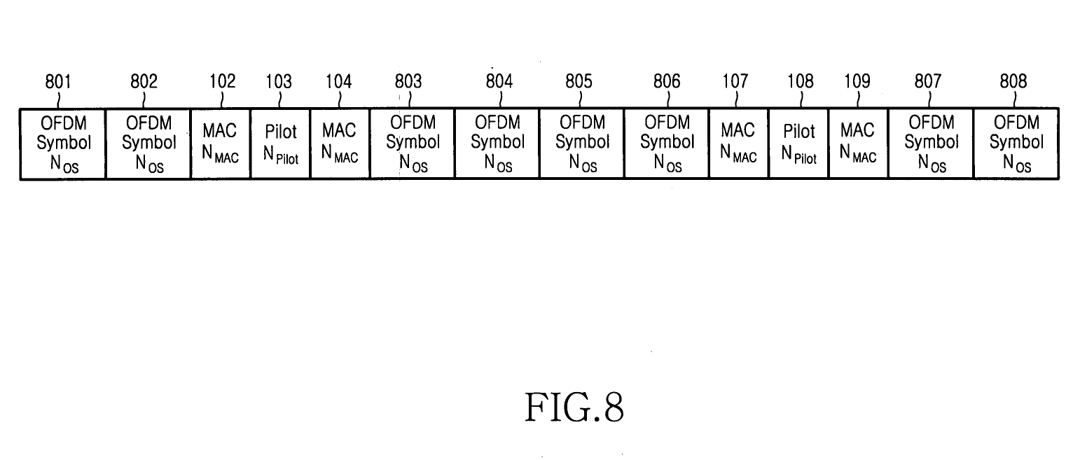

FIG. 8 illustrates a structure of one slot with a uniform OFDM symbol size in the HRPD system according to the above-described first and third schemes in accordance with an embodiment of the present invention. The structure of one slot with a uniform OFDM symbol size will be described with reference to FIG. 8.

In FIG. 8, it is assumed that OFDM symbols into which data is inserted are input two by two as an example. That is, two OFDM symbols 801 and 802 are inserted into the first half slot of the one slot. An MAC signal part 102 is placed subsequent to the symbols 801 and 802. A pilot part 103 is placed subsequent to the MAC signal part 102. Two symbols 803 and 804 are placed subsequent to the MAC signal part 102. In more detail, two N_{OS}-chip OFDM symbols 801 and 802 are placed before the first MAC signal part 102, and four N_{OS}-chip OFDM symbols 803, 804, 805, and 806 are placed between the second MAC signal part 104 and the third MAC signal part 107. Two N_{OS}-chip OFDM symbols 807 and 808 are placed after the fourth MAC signal part 109. That is, FIG. 8 illustrates an example of a slot structure for transmitting a forward compatible OFDM symbol in the HRPD system.

In another embodiment, OFDM symbols with the same size as that of a data signal of FIG. 1 may be inserted in place of data signal parts 101, 105, 106, and 110 of FIG. 1.

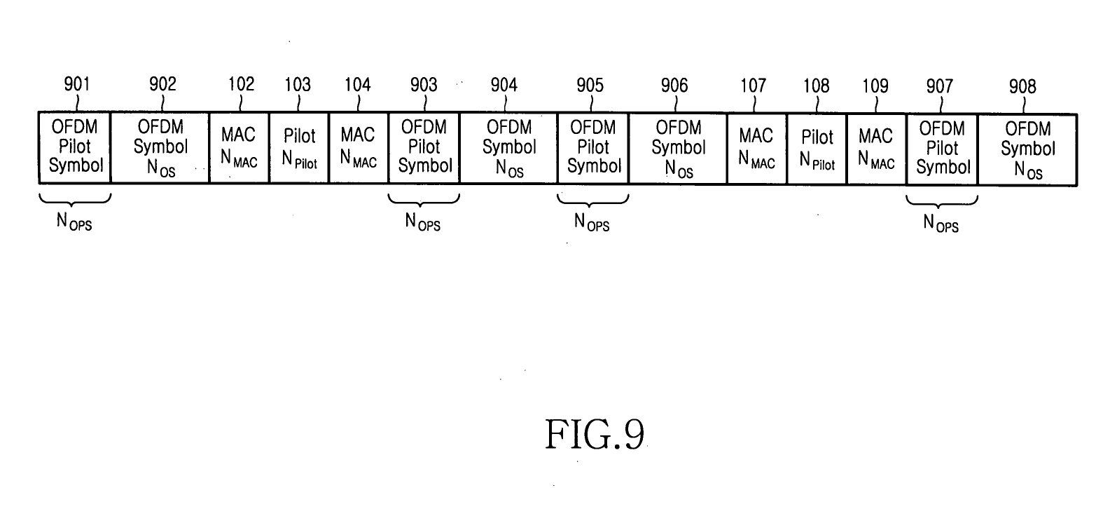

FIG. 9 illustrates an example in which some OFDM symbols are used as OFDM pilot symbols when OFDM symbols have different sizes. The example will now be described in more detail with reference to FIG. 9.

To demodulate an OFDM symbol, a terminal receiver needs a pilot signal for estimating each OFDM subcarrier channel. However, because pilot signal parts 103 and 108 inserted into the conventional HRPD slot do not use an OFDM modulation scheme, they are affected by self-interference. Because the pilot signal parts 103 and 108 are spread by different pseudo random noise (PN) codes base station by base station, they cannot be used to estimate a channel through macro diversity. An OFDM pilot signal needs to be additionally transmitted for OFDM symbol demodulation. Accordingly, a pilot tone is inserted at each OFDM symbol, or an OFDM pilot symbol is separately inserted. The slot structure of FIG. 9 is an example in which a pilot tone is not inserted, but N_{OPS}-chip OFDM pilot symbols 901, 903, 905, and 907 are inserted. In the embodiment of FIG. 9, an OFDM symbol size can be N_{OPS}+N_{OS}=N_{DATA}=400 chips. For example, an OFDM symbol size can be configured as in the following: N_{OPS}=104 chips, N_{OS}=296 chips, and N_{CP}=40 chips.

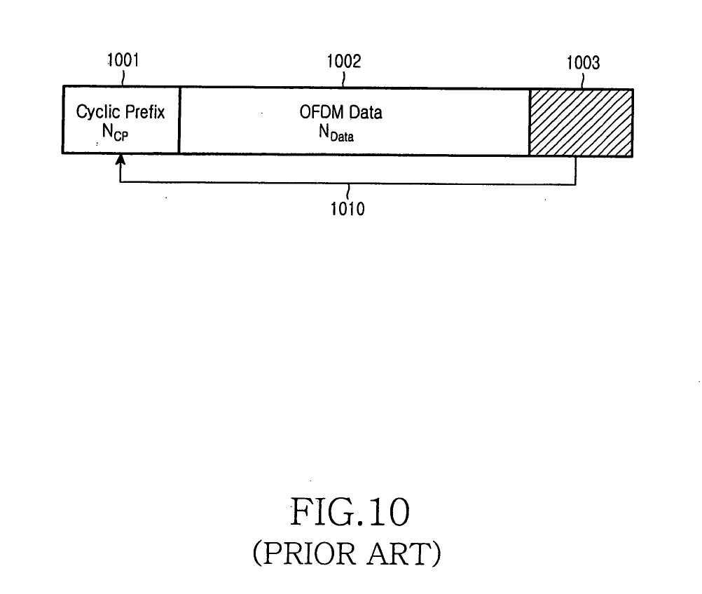

Here, N_{CP} denotes a size of a CP. The CP will be described in more detail with reference to FIG. 10. The number of Fourier Transform points for an OFDM pilot symbol is 64, and the number of Fourier Transform points for an OFDM data symbol is 256. Because Radix-4 or Radix-8 based FFT can be applied, the number of Fourier Transform computations can be effectively reduced.

In more detail, an FFT algorithm is basically defined in terms of Radix-2, that is, a power of 2. An FFT algorithm for an arbitrary size is being developed, but an increased number of computations are required. Accordingly, to effectively reduce the number of computations in the FFT algorithm, Radix-4 or Radix-8 based FFT is used. Therefore, symbols used in embodiments of the present invention are associated with a power of 4 or 8. In the above-described examples, the Radix-8 based FFT algorithm can be applied when the number of Fourier Transform points is 64 (=8²), and the Radix-4 based FFT algorithm can be applied when the number of Fourier Transform points is 256 (=4⁴), such that the number of FFT computations can be effectively reduced.

FIG. 10 illustrates a structure of a conventional transmission OFDM symbol. The structure and function of the conventional transmission OFDM symbol will now be described in more detail with reference to FIG. 10. An OFDM symbol of FIGS. 7 to 9 is configured as illustrated in FIG. 10. An OFDM symbol 1002 to be transmitted is OFDM data on which an Inverse Fast Fourier Transform (IFFT) operation has been performed. N_{CP}-chip information 1003 serving as partial OFDM data placed after the OFDM data 1002 is copied, and the copied information is added before the OFDM data, and forms a CP 1001. The CP 1001 is used to prevent self-interference due to a received signal component delayed through multiple paths. Accordingly, a size of an N_{CP}-chip CP 1001 is set such that it is basically not smaller than a value of the maximum delay time occurring in a channel. That is, a CP 1001 size must be set such that it is greater than or equal to a value of the maximum delay time occurring in a channel.

Accordingly, when a broadcast or multicast service is provided, a signal of an OFDM symbol transmitted from a different base station must be able to be identified, the CP 1001 size must be set to be sufficiently large according to reception delay time of a signal from the different base station. Information of the CP 1001 is only used to securely transmit data without interference, but does not increase an amount of information. However, when the CP 1001 size is set to be very large, transmission efficiency is degraded. The CP 1001 size must be suitably determined on the basis of a cell radius or allowable multipath delay time.

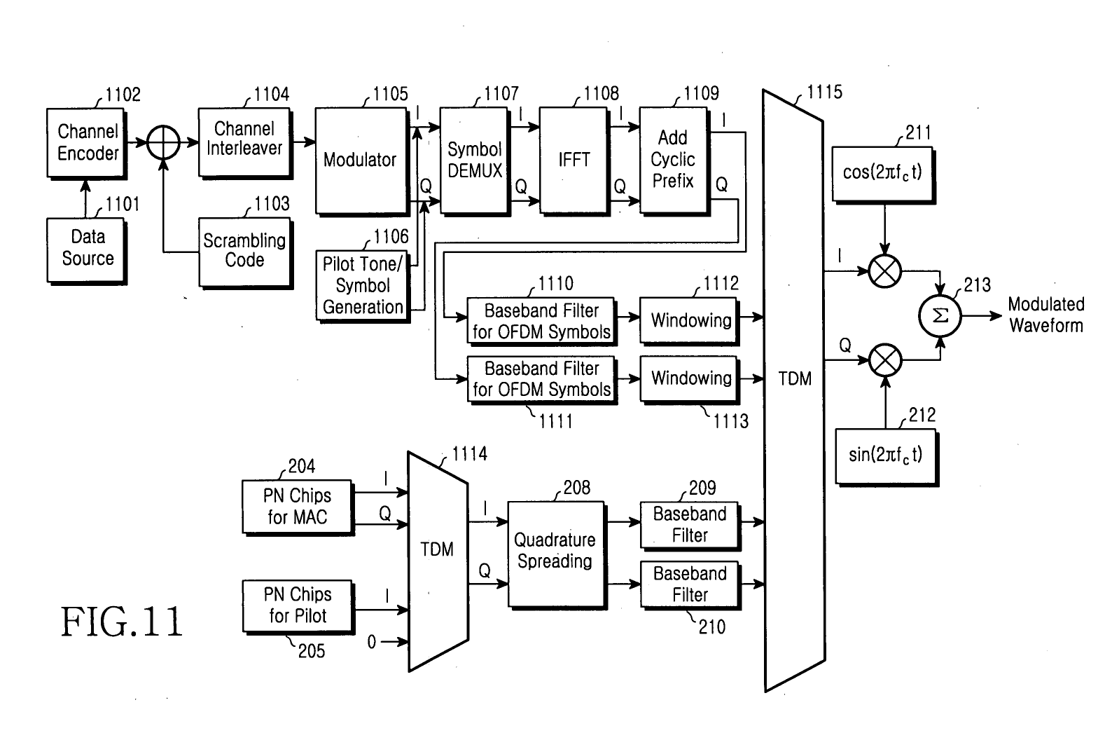

FIG. 11 is a block diagram illustrating a base station for transmitting the forward compatible OFDM symbol slot illustrated in FIGS. 7 to 9 in the IRPD system. The configuration and operation of the base station for transmitting the forward compatible OFDM symbol slot in the HRPD system will be described with reference to FIG. 11.

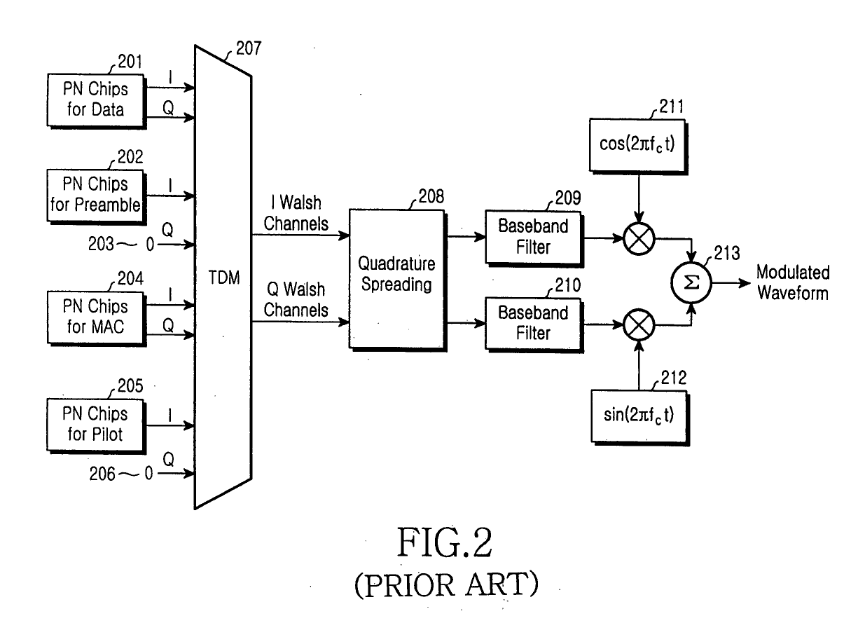

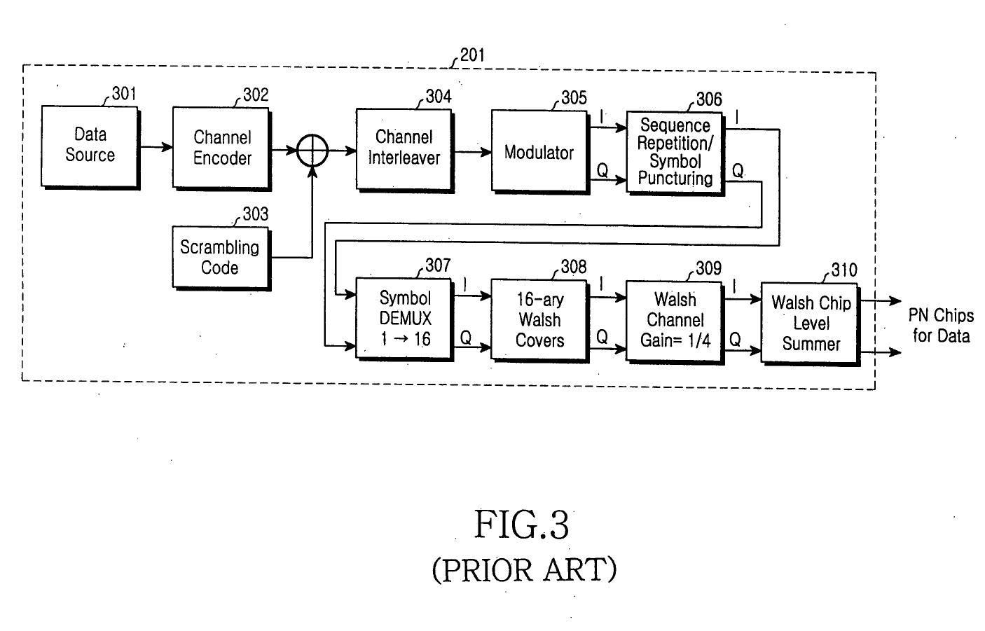

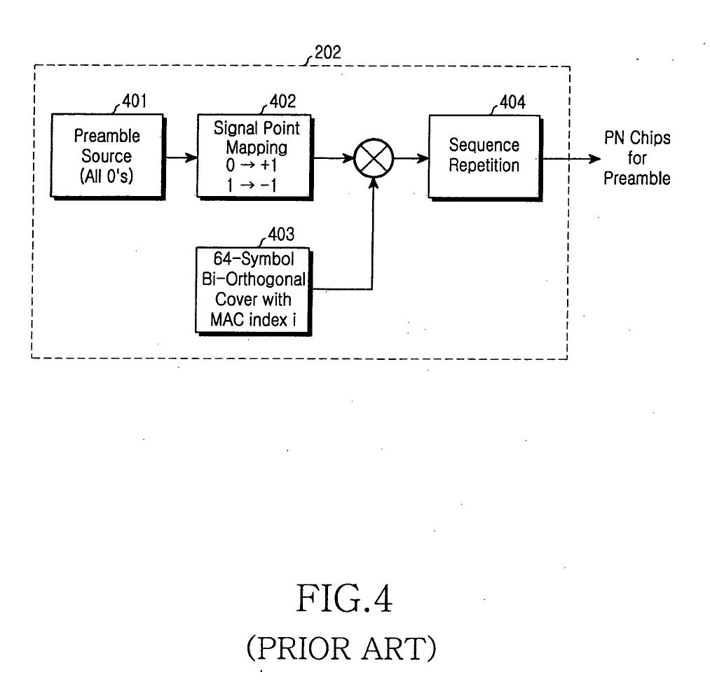

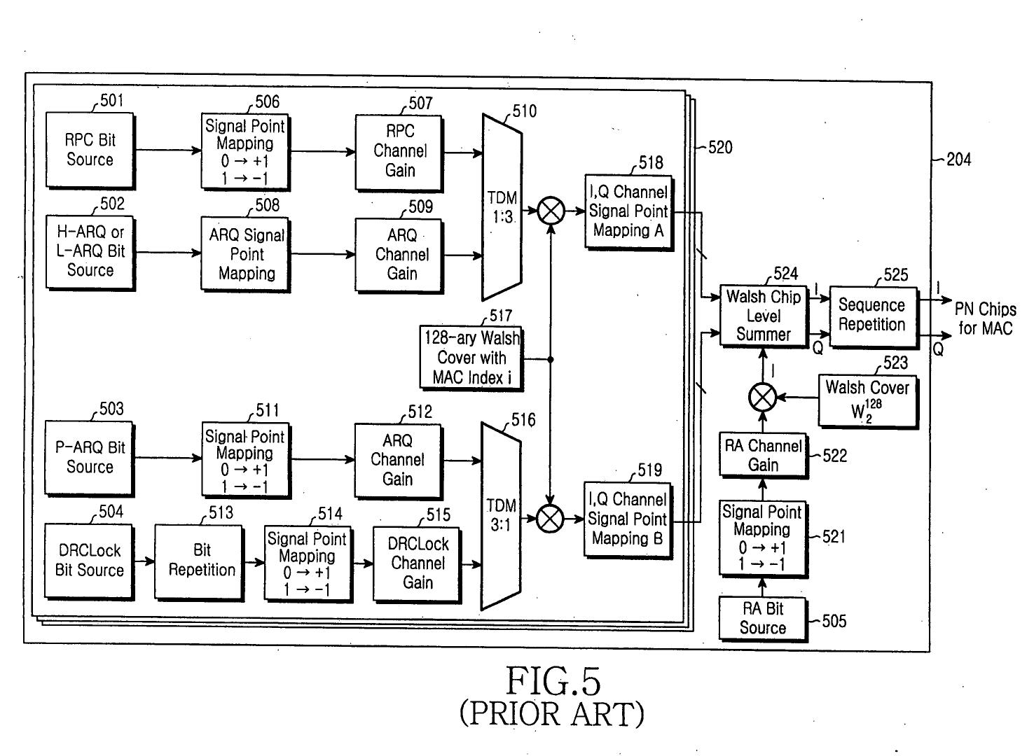

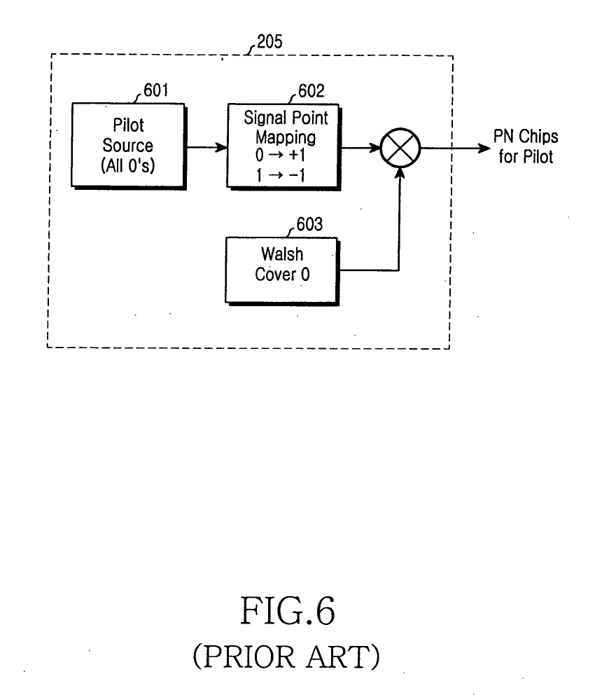

To maintain the compatibility with the conventional HRPD forward link structure, MAC signals 102, 104, 107, and 109 and pilot signals 103 and 108 are generated in the same way that they are generated from the generators 204 and 205 of FIGS. 5 and 6. A time division multiplexer 1115 generates OFDM symbols for data signals 101, 105, 106, and 110, and performs TDM such that MAC signals 102, 104, 107, and 109 and pilot signals 103 and 108 are arranged as in the slot structure of FIGS. 7 to 9. Before the TDM is performed, the MAC signals 102, 104, 107, and 109 and the pilot signals 103 and 108 must be time-divided. Accordingly, a time division multiplexer 1114 performs the TDM on the MAC signals 102, 104, 107, and 109 and the pilot signals 103 and 108, and outputs a result of the TDM. As described in relation to FIG. 2, a quadrature spreader 208 spreads output signals of the time division multiplexer 1114. The spread signals are filtered through the conventional baseband filters 209 and 210. Before a time division mutliplexer 1115 performs the TDM, the quadrature spreader 208 and the filters 209 and 210 perform spreading and filtering operations. These operations are performed because the MAC signals 102, 104, 107, and 109 and the pilot signals 103 and 108 must shape a waveform according to the conventional HRPD system such that compatibility can be maintained. However, an OFDM symbol is generated according to a different scheme for OFDM transmission efficiency.

The process for generating an OFDM symbol is as follows. First, a data source 1101 of a broadcast signal is encoded through a channel encoder 1102. A scrambling operation is performed by multiplying the encoded broadcasting signal by a scrambling code generated from a scrambling code generator 1103. The scrambling code generator 1103 is a device for generating the scrambling code to be used for scrambling. A signal generated from the scrambling code generator 1103 and an encoded data signal output from the channel encoder 1102 are scrambled through a mod-2 operation. A channel interleaver 1104 interleaves the result of the scrambling in the time domain. A modulator 11 05 modulates an output signal of the channel interleaver 1104. Because OFDM does not generate self-interference and can prevent intercell interference using a single frequency network (SFN) based macro diversity scheme, a high-level modulation scheme such as quadrature amplitude modulation (QAM) can be applied. A pilot tone/symbol generator 1106 generates pilot tones/symbols to be inserted at symbol data modulated by the modulator 1105. Accordingly, the generated pilot tones/symbols are inserted at the modulated symbol data from the modulator 1105. Subsequently, a symbol demultiplexer 1107 performs a demultiplexing operation to generate OFDM symbol data. The modulated signals are separated into units for generating individual OFDM symbols. Through an IFFT processor 1108, the modulated signals are mapped to subcarriers. Subsequently, a CP adder 1109 adds CPs to signals output from the IFFT processor 1108 to generate OFDM symbols as illustrated in FIG. 10.

The OFDM symbols are processed through baseband filters 1110 and 1111 and windowing processors 1112 and 1113 such that the OFDM symbols are easily sampled and given band characteristics are satisfied. Because band characteristics of an OFDM signal are different from those of the conventional HRPD signal, different baseband filters may be used.

The baseband filters 1110 and 1111 modify a shape of a signal pulse forming OFDM symbols, and are used to determine the entire frequency band characteristics of the OFDM symbols. Conventionally, a communication and broadcasting system using a radio wave does not propagate energy of a different frequency band according to a guideline. The baseband filters 1110 and 1111 are used to satisfy the guideline. Similarly, the baseband filters 209 and 210 are used for the conventional HRPD signal. However, when OFDM is used, its frequency band characteristics are influenced by frequency band characteristics of each subcarrier. Accordingly, the HRPD baseband filters 209 and 210 do not need to be the same as the OFDM baseband filters 1110 and 1111.

The windowing processors 1112 and 1113 modify a pulse shape of each OFDM symbol, and are used to determine the frequency band characteristics of each subcarrier. When windowing is not applied, out-of-band emission from each subcarrier increases. Accordingly, out-of-band characteristics of the entire OFDM signal are degraded. When a frequency offset of a receiver occurs, interference between subcarriers increases. To reduce adjacent channel interference of an OFDM signal, windowing may be used, or a virtual subcarrier may be used such that no signal is transmitted through a subcarrier on a band boundary. However, the latter method degrades transmission efficiency because some subcarriers are not used for signal transmission. The order of the baseband filters 1110 and 1111 and the windowing processors 1112 and 1113 may be changed.

Output signals of the windowing processors 1112 and 1113 are I and Q channel signals. When an HRPD slot comprising OFDM symbols is completed through the TDM process of the time division multiplexer 1115, a cosine carrier 211 and a sine carrier 212 are multiplied by the I and Q channel signals, respectively. A summer 213 sums multiplication results, such that a final transmission RF signal is produced.

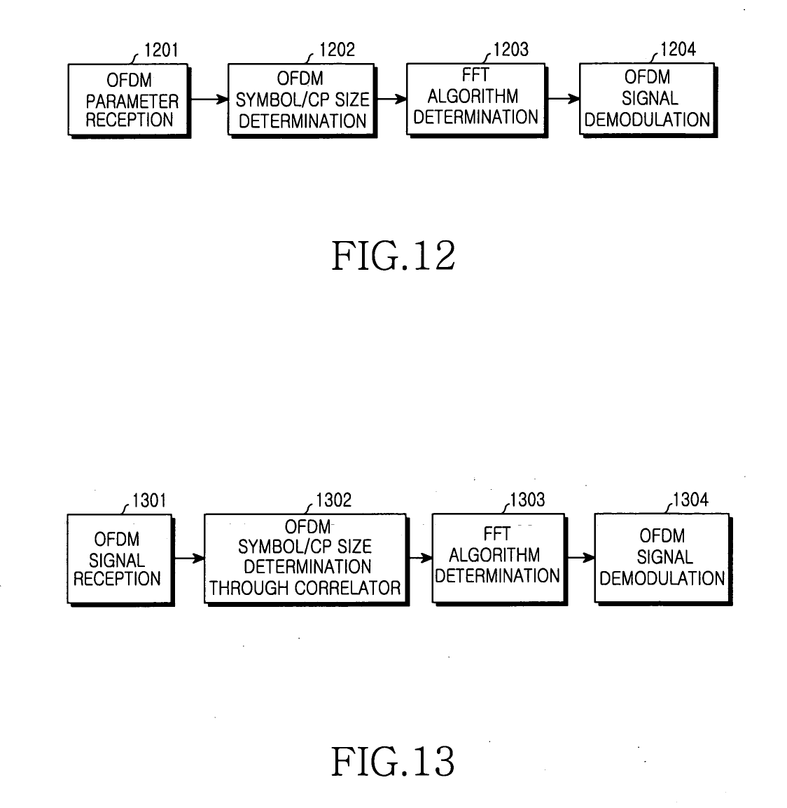

FIGS. 12 and 13 are flow charts illustrating a multimode OFDM scheme of a receiver. As described above, embodiments of the present invention propose a transmission method for varying an OFDM symbol size and a CP size according to characteristics of broadcasting content. For this, the transmitter can use a parameter notification method and a parameter non-notification method. The former method allows the receiver to exactly identify the transmission method, but degrades transmission efficiency because parameters must be sent. However, when the latter method wrongly estimates parameters at the time of reception, a reception error occurs. In the latter method, transmission efficiency is not degraded because no parameter is sent.

FIG. 12 is a flow chart illustrating an operation for processing data received in the receiver when the parameters are sent according to the parameter notification method. The operation for processing the data received in the receiver will be described with reference to FIG. 12.

Because the transmitter notifies the receiver of information about an OFDM symbol size and a CP size, parameters are received in step 1201. The OFDM symbol size and the CP size are determined in step 1202. According to a result of the determination, an FFT size is determined in step 1203. When the FFT size has been determined, an OFDM signal can be demodulated in step 1204.

FIG. 13 is a flow chart illustrating an operation for processing data received in the receiver when the transmitter does not send a parameter. The operation for processing the data received in the receiver will be described with reference to FIG. 13.

The transmitter does not give notification of an OFDM symbol/CP size. However, because a CP has a repeat form in the front and rear parts of an OFDM symbol, the receiver can identify a size and position of a CP through a correlator (not illustrated). In step 1301, the receiver receives an OFDM signal and stores the received signal in a buffer (not illustrated). In step 1302, the receiver can estimate and determine the OFDM symbol size and the CP size from the stored signal through the correlator. According to a result of the determination, an FFT size is determined in step 1303. When the FFT size has been determined, an OFDM signal can be demodulated in step 1304.

The above-described slot structure for transmitting an HRPD forward compatible OFDM symbol can be applied to other wireless packet mobile communication systems. An example in which the slot structure is applied to other systems will be described.

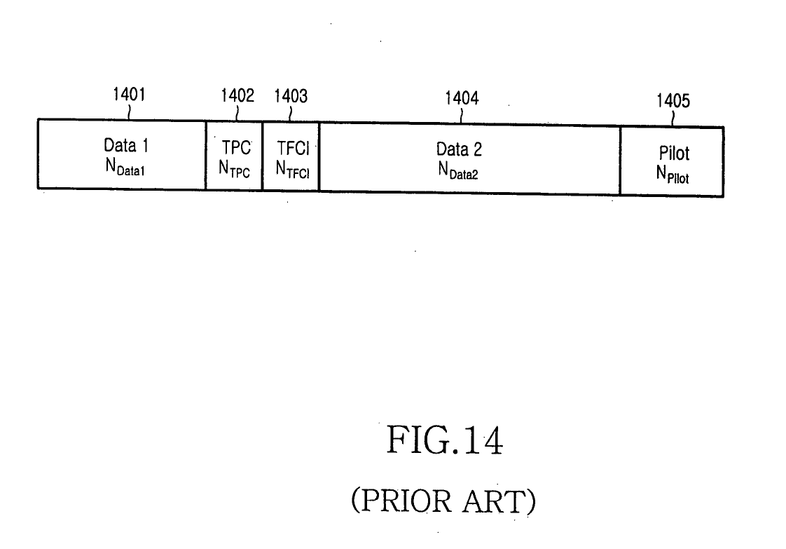

FIG. 14 illustrates a slot structure of a forward link in a universal mobile telecommunications system (UMTS) system in frequency domain duplex (FDD) mode. Now, the slot structure of the UMTS forward link in the FDD mode will be described.

In a channel to be transmitted to a forward link in a UMTS system in the FDD mode, one slot includes two data parts 1401 and 1404. Along with the data parts 1401 and 1404, transmit power control (TPC) information 1402, a transport format combination indicator (TFCI) 1403, and a pilot 1405 are multiplexed and transmitted through TDM. The TPC information 1402 indicates transmission power of traffic to be transmitted in the forward direction, and is transmitted through a dedicated physical control channel (DPCCH). The TFCI 1403 is an indicator indicating the transport format combination when data of a physical layer is multiplexed into one or more channels and the multiplexed data is transmitted. The UMTS system with the above-described structure can also transmit broadcasting service data according to the OFDM scheme as proposed by embodiments of the present invention.

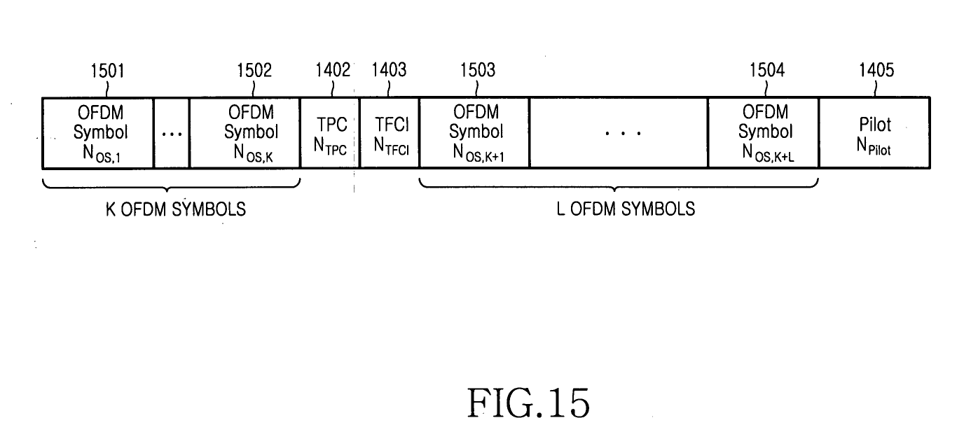

FIG. 15 illustrates a slot structure for providing a broadcasting service using an OFDM symbol in a UMTS system in accordance with an embodiment of the present invention. Now, the slot structure when the broadcasting service is provided using an OFDM symbol in the UMTS system in accordance with the present invention will be described in more detail with reference to FIG. 15.

The TPC information 1402, the TFCI 1403, and the pilot 1405 of the slot structure in FIG. 15 have the same positions and the same sizes as those of the slot structure in FIG. 14, such that the slot structure of FIG. 15 is compatible with the slot structure of the forward link in the UMTS system in the FDD mode. As described in relation to FIG. 14, a broadcasting OFDM symbol is placed in a data part into which data of FIG. 14 is inserted. That is, OFDM symbols 1501, . . . , 1502, 1503, . . . , 1504 in FIG. 15 correspond to the data parts of FIG. 14. Each OFDM symbol size must satisfy Equation (2) according to position, where K and L are integers and N_{OS} denotes a broadcasting data symbol size.
Total number of OFDM symbols: {N_{OS,i}}_{i=1,} . . . _{,K+L} (Unit: chip)
K OFDM symbols: N_{OS,1}+N_{OS,2}+ . . . +N_{OS,K-1}+N_{OS,K}=N_{Data1} (Unit: chip)
L OFDM symbols: N_{OS,K+1}+N_{OS,K+2}+ . . . +N_{OS,K+L-1}+N_{OS,K+L}=N_{Data2} (Unit: chip) Equation (2)

According to Equation (2), OFDM symbols determine the length of a CP as described in relation to FIG. 10. The last part of each symbol is copied according to the CP length, and the copied part is added as a CP to the head part of each symbol. This process is also applied in a previous embodiment. OFDM symbol sizes in different embodiments may be the same as or different from each other.

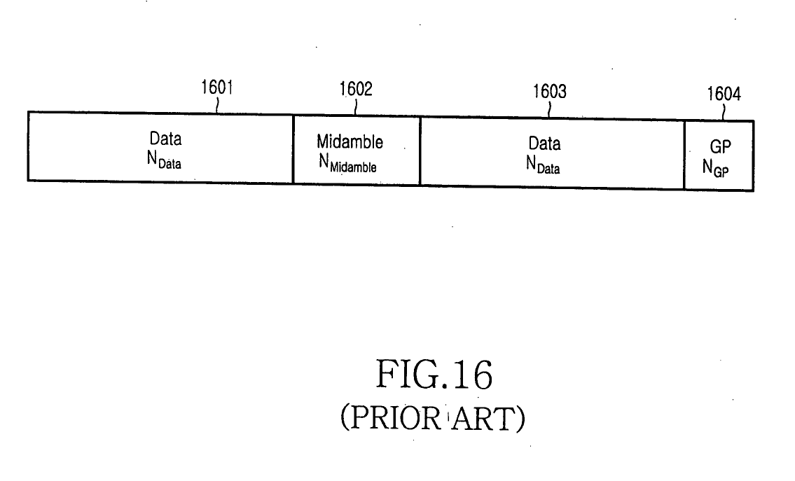

FIG. 16 illustrates a conventional slot structure of a forward link in a UMTS system in time domain duplex (TDD) mode. The slot structure of the forward link in the UMTS system in the TDD mode will be described with reference to FIG. 16.

As illustrated in FIG. 16, it can be seen that data parts 1601 and 1603 are multiplexed and transmitted using TDM along with a midamble 1602. To prevent interference due to a synchronous error between slots according to operation characteristics, a guard period (GP) 1604 is placed in the last part of each slot. The UMTS system using the TDD mode can also transmit broadcasting service data using an OFDM symbol. An example in which a broadcasting service data symbol is inserted will now be described in more detail.

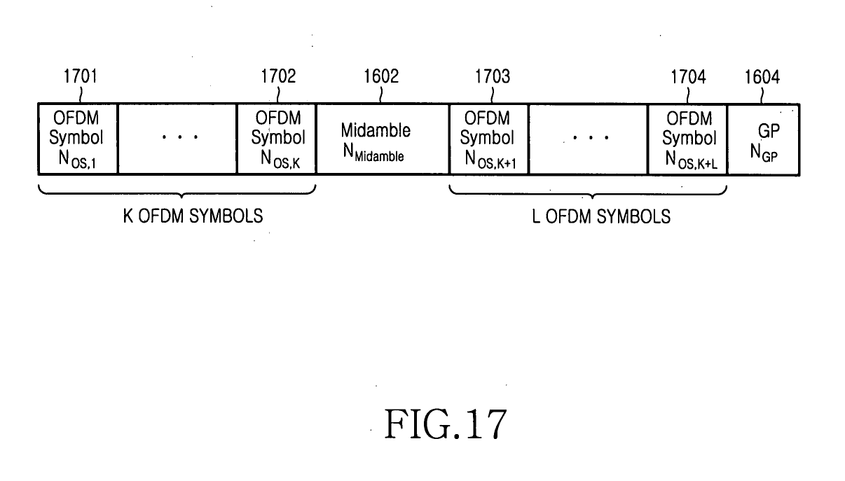

FIG. 17 illustrates a structure of a slot for providing a broadcasting service using an OFDM symbol in a UMTS system in accordance with another embodiment of the present invention. The configuration and operation of the slot for-providing a broadcasting-service through the OFDM symbol in the UMTS system will be described with reference to FIG. 17.

FIG. 17 illustrates an example in which an OFDM symbol insertion method proposed according to an embodiment of the present invention is applied to the UMTS system in the above-described TDD mode.

A midamble 1602 and a GP 1604 of the slot structure in FIG. 17 have the same positions and the same sizes as those of the slot structure in FIG. 16, such that the slot structure of FIG. 17 is compatible with the slot structure of the forward link in the UMTS system in the TDD mode. OFDM symbols 1701, . . . , 1702, 1703, . . . , 1704 of FIG. 17 replace the data parts of FIG. 16. An OFDM symbol size must satisfy Equation (3) according to position, where K and L are integers and N_{OS} denotes a broadcasting data symbol size.
Total number of OFDM symbols: {N_{OS,i}}_{i=1,} . . . _{,K+L} (Unit: chip)
K OFDM symbols: N_{OS,1}+N_{OS,2}+ . . . +N_{OS,K-1}+N_{OS,K}=N_{Data} (Unit: chip)
L OFDM symbols: N_{OS,K+1}+N_{OS,K+2}+ . . . +N_{OS,K+L-1}+N_{OS,K+L}=N_{Data} (Unit: chip) Equation (3)

As is apparent from the above description, embodiments of the present invention can transmit broadcasting data using orthogonal frequency division multiplexing (OFDM) symbols in a mobile communication system, can reduce interference between symbols received from a plurality of base stations and self-interference, and can provide a two-way service using a unique function of the mobile communication system.

1. A method for providing a broadcasting service in a mobile communication system for transmitting packet data, comprising the steps of:
encoding and modulating broadcasting service data, and demultiplexing the modulated data into data streams corresponding to a number of orthogonal frequency subcarriers;
transforming the data streams using Fast Fourier Transform (FFT), and multiplexing the transformed data streams using orthogonal frequency division multiplexing (OFDM);
copying information with a predetermined length placed in a last part of OFDM data, adding the copied information as a cyclic prefix (CP) to a head part of the OFDM data, and generating OFDM symbols to be transmitted; and
multiplexing the generated OFDM symbols into a forward channel of the mobile communication system, and transmitting the multiplexed OFDM symbols.

2. The method according to claim 1, wherein before the step of demultiplexing the modulated data, inserting pilot parts for channel estimation when the OFDM symbols are transmitted.

3. The method according to claim 1, wherein the OFDM symbols are configured to have a same size.

4. The method according to claim 1, wherein a symbol size in the OFDM symbols is determined by characteristics of data to be transmitted symbol by symbol.

5. The method according to claim 1, wherein the OFDM symbols have a same size during one slot, and a symbol size in different slots is determined by characteristics of data to be transmitted.

6. The method according to claim 1, wherein when the mobile communication system is a high rate packet data (HRPD) system, the multiplexing step comprises:
multiplexing medium access control (MAC) and pilot symbols, generated by a code division multiple access (CDMA) scheme, into a MAC and pilot transmission position within one slot; and
multiplexing the OFDM symbols into a data symbol position.

7. The method according to claim 6, wherein before the step of demultiplexing the modulated data, inserting pilot parts for channel estimation when the OFDM symbols are transmitted.

8. The method according to claim 7, wherein a size of the OFDM symbols is configured by N_{OPS}=104 chips, N_{OS}=296 chips, and N_{CP}=40 chips, where N_{OPS} denotes a pilot symbol size, N_{OS} denotes a broadcasting data symbol size, and N_{CP} denotes a cyclic prefix (CP) symbol size.

9. The method according to claim 6, further comprising the steps of:
multiplexing separate pilot tones/symbols and transmitting the multiplexed pilot tones/symbols, before the OFDM symbols multiplexed into the data symbol position are transmitted.

10. The method according to claim 9, wherein a size of the OFDM symbols is configured by N_{OPS}=104 chips, N_{OS}=296 chips, and N_{CP}=40 chips, where N_{OPS} denotes a pilot symbol size, N_{OS} denotes a broadcasting data symbol size, and N_{CP} denotes a cyclic prefix (CP) symbol size.

11. The method according to claim 1, wherein when the mobile communication system is a universal mobile telecommunications system (UMTS) system in frequency domain duplex (FDD) mode, the multiplexing step comprises the steps of:
multiplexing transmit power control (TPC), transport format combination indicator (TFCI) and pilot symbols, generated by a code division multiple access (CDMA) scheme, into a UMTS symbol position; and
multiplexing the OFDM symbols into a data symbol position.

12. The method according to claim 11, wherein before the step of demultiplexing the modulated data, inserting pilot parts for channel estimation when the OFDM symbols are transmitted.

13. The method according to claim 11, further comprising the steps of:
multiplexing separate pilot tones/symbols and transmitting the multiplexed pilot tones/symbols, before the OFDM symbols multiplexed into the data symbol position are transmitted.

14. The method according to claim 1, wherein when the mobile communication system is a universal mobile telecommunications system (UMTS) system in time domain duplex (TDD) mode, the multiplexing step comprises the steps of:
multiplexing midamble and guard period (GP) symbols, both generated by a code division multiple access (CDMA) scheme, into a UMTS symbol position; and
multiplexing the OFDM symbols into a data symbol position.

15. The method according to claim 14, wherein before the step of demultiplexing the modulated data, inserting pilot parts for channel estimation when the OFDM symbols are transmitted.

16. The method according to claim 14, further comprising the steps of:
multiplexing separate pilot tones and transmitting the multiplexed pilot tones, before the OFDM symbols multiplexed into the data symbol position are transmitted.

17. An apparatus for providing a broadcasting service in a high rate packet data (HRPD) system, comprising:
an encoder for performing a channel encoding operation on broadcasting service data according to a predetermined encoding scheme;
a modulator for modulating the encoded broadcasting service data according to a predetermined modulation scheme;
a demultiplexer for demultiplexing the modulated data into data streams corresponding to a number of orthogonal frequency subcarriers;
a Fast Fourier Transform (FFT) processor for transforming the data streams using FFT, and multiplexing the transformed data streams using orthogonal frequency division multiplexing (OFDM);
a cyclic prefix (CP) adder for copying information with a predetermined length placed in a last part of OFDM data, adding the copied information as a CP to a head part of the OFDM data, and generating OFDM symbols to be transmitted; and
a multiplexer for multiplexing the generated OFDM symbols into a forward channel of the mobile communication system.

18. The apparatus according to claim 17, further comprising:
a pilot symbol generator for generating pilot symbols of OFDM to be inserted, and outputting, to the demultiplexer, the generated pilot symbols along with the modulated data.

19. The apparatus according to claim 17, wherein the OFDM symbols are configured to have a same size.

20. The apparatus according to claim 17, wherein a symbol size in the OFDM symbols is determined by characteristics of data to be transmitted symbol by symbol.

21. The apparatus according to claim 17, wherein the OFDM symbols are generated in a same size during one slot, and a symbol size in different slots is determined by characteristics of data to be transmitted.

22. A method for receiving broadcasting service data in a mobile communication system, the mobile communication system configuring the broadcasting service data using orthogonal frequency division multiplexing (OFDM) symbols in a high rate packet data (HRPD) system, and providing the OFDM symbols, comprising:
receiving parameters associated with received OFDM symbols from a transmitter;
determining an OFDM symbol size and a cyclic prefix (CP) symbol size using the received parameters;
determining a Fast Fourier Transform (FFT) algorithm for the OFDM symbols using the received parameters; and
demodulating the received OFDM symbols.

23. A method for receiving broadcasting service data in a mobile communication system, the mobile communication system configuring the broadcasting service data using orthogonal frequency division multiplexing (OFDM) symbols in a high rate packet data (HRPD) system, and providing the OFDM symbols, comprising:
storing OFDM symbols received from a transmitter;
determining an OFDM symbol size and a cyclic prefix (CP) symbol size using a correlator;
determining a Fast Fourier Transform (FFT) algorithm for the OFDM symbols using the determined OFDM symbol size and the determined CP symbol size; and
demodulating the received OFDM symbols.
